(19) United States
(12) Patent Application Publication
(10) Pub. No.: US 2023/0266608 A1
(43) Pub. Date: Aug. 24, 2023

(54) HINGE FOR EYEWEAR

(71) Applicant: Fitz Frames, Inc., Santa Monica, CA (US)

(72) Inventors: Katie Brandeau, Pasadena, CA (US); Nicholas Torres, Ambridge, PA (US)

(21) Appl. No.: 18/172,694

(22) Filed: Feb. 22, 2023

Related U.S. Application Data
(60) Provisional application No. 63/313,075, filed on Feb. 23, 2022.

(51) Int. Cl. G02C 5/22

(52) U.S. Cl. CPC G02C 5/2209

(57) ABSTRACT

A hinge mechanism for eyeglasses which enables replacement of the temples from a lens frame without the need for any pins or tools, and without small or weak parts. The hinge mechanism between each of the temples and the lens frame includes a male component which fits into a female component and may be adjusted in two ways. The torque required to assemble the temples to the lens frame can be adjusted, as well as the torque required to transition the temples from the folded to the unfolded position. Both adjustments may be affected by the choice of materials of one or both of the hinge components. The male component may be on the end of each of the temples and sized to fit within the female component on either end of the lens frame. Rotating the temples 90° snaps them into place, and they can easily be removed by the reverse operation.

### RELATED APPLICATION INFORMATION

This application claims priority to Provisional Application Ser. No. 63/313,075, filed Feb. 23, 2022 entitled “HINGE FOR EYEWEAR”, which is hereby incorporated by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to hinges for eyewear.

### Description of the Related Art

Eyewear includes eyeglasses, sunglasses, prop glasses, specialty glasses, and variations of these. Eyewear typically has temples, also called earpieces or ear stems. A single pair of glasses may have different colors, shapes and styles of temples attached to one lens frame.

Replaceable temples or ear stems are known. For example, U.S. Pat. Nos. 4,153,347; 5,652,637; 7,744,212; and 9,400,398, among others, disclose interchangeable temples for eyeglasses. Most of these require tools or have small attachment screws or the like, and are thus somewhat cumbersome to attach and detach, and/or prone to loss or breakage of key attachment pieces.

### DESCRIPTION OF THE DRAWINGS

FIG. 1 is a perspective exploded view of one end of a lens frame and temple of the present application illustrating an exemplary hinge mechanism, while FIG. 2 is a first step of assembly of a temple to the lens frame.

FIG. 3 is a perspective view of a second step of assembly of the temple to lens frame.

FIG. 4 illustrates the assembled lens frame and temple after rotating the temple to a deployed configuration.

FIGS. 5A and 5B are enlarged perspective views of an exemplary female hinge component at different angles, and FIG. 5C is a rear elevational view thereof.

FIG. 6A is an enlarged perspective view of the hinge mechanism during a first step of assembly of the temple to the lens frame, and FIG. 6B is the same view with the hinge mechanism shown in phantom.

FIG. 7A is an enlarged perspective view of the hinge mechanism during a second step of assembly of the temple to the lens frame, and FIG. 7B is the same view with the hinge mechanism shown in phantom.

FIG. 8A is a horizontal sectional view through the female hinge component as taken along line 8A-8A of FIG. 5A.

FIG. 8B is a horizontal sectional view through the assembled hinge mechanism taken along line 8B-8B of FIG. 7A.

FIG. 9A is an enlarged perspective view of the hinge mechanism in phantom with the assembled temple being rotated toward a toward an unfolded configuration, and FIG. 9B is the same view after unfolding of the temple.

### DETAILED DESCRIPTION

A hinge mechanism for eyeglasses is disclosed which enables replacement of the temples from a lens frame without the need for any pins or tools, and without small or weak parts. The hinge mechanism between each of the temples and the lens frame includes a male component which fits into a female component, and may be adjusted in two ways. The torque required to assemble the temples to the lens frame can be adjusted, as well as the torque required to transition the temples from the folded to the unfolded position. Both adjustments may be affected by the choice of materials of one or both of the hinge components. The male component may be on the end of each of the temples and sized to fit within the female component on either end of the lens frame. Rotating the temples 90° snaps them into place, and they can easily be removed by the reverse operation.

The hinge mechanism enables easy assembly and replacement of one or both of the temples with different temples. The primary advantages of being able to replace the temples is if one or the other breaks, to replace it with a new one, and also to change the look of the eyeglasses.

The hinge mechanism is provided on both lateral ends of the lens frame so that two temples can be attached. As such, the hinge mechanism on each end includes mating components, one of which is on the lens frame and one of which is on the temple. In the illustrated embodiment, a female component of the hinge mechanism is provided on the lens frame, while a male component is on each of the temples. It is contemplated that the male/female relationship of the two components might be reversed, though economics dictate that the male component is on the temple. Furthermore, the female component of the hinge mechanisms on opposite ends of the lens frame are desirably identical, so as to mate with temples having identical male components. However, the two hinge mechanisms on the lens frame may be configured differently so as to require different mail components on either side, though this also is considered less advantageous. Identical temples can be coupled with the female component of the hinge mechanism on either end of the lens frame. However, depending on the design, temples may be specific to the left or right hinge mechanism on a lens frame.

Hinge mechanisms disclosed herein are particularly well-suited to the creation of bespoke eyewear. That is, supplying a single lens frame with multiple types and designs of temples is one option. Moreover, the methodology disclosed in U.S. Pat. No. 11,069,153 assigned to Fitz Frames, Inc. of Santa Monica, Calif. greatly benefits from the hinge mechanisms disclosed herein. The '153 patent, incorporated herein, discloses a computer implemented method in which manufacturers can readily produce different temples for a variety of lens frames, and customize the assembly with customer input using an app-based program. The temples for any one pair of lens frames may be easily fabricated using 3-D modeling technology, and thus a replacement pair of temples can be quickly ordered, manufactured, and shipped. The hinge mechanism of the present application enables easy interchangeability of the temples with the lens frames.

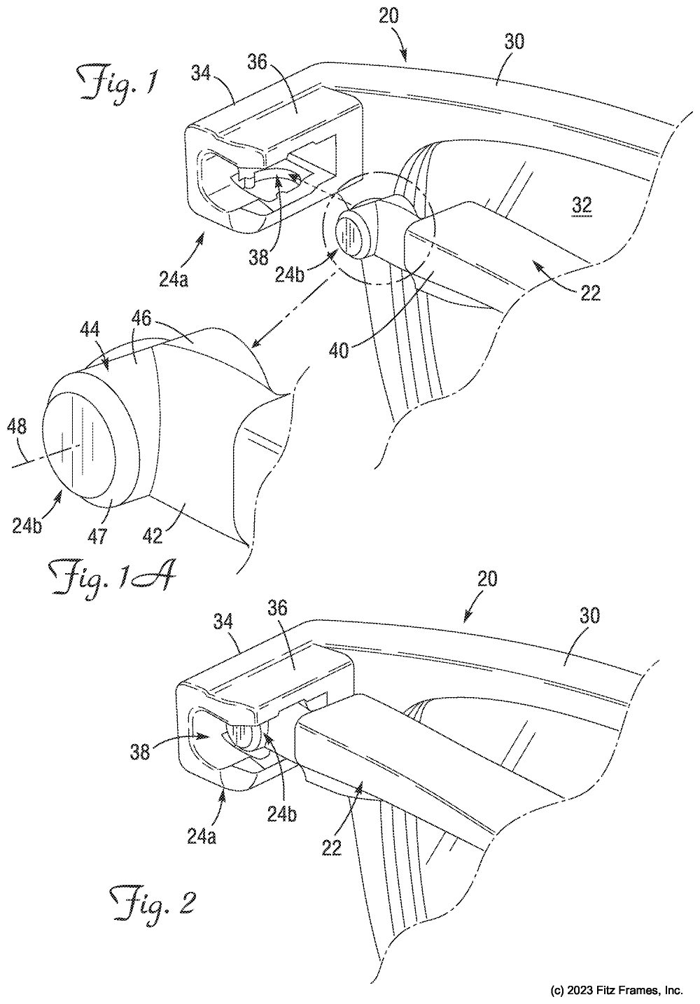

FIG. 1 is a perspective exploded view of one end of a lens frame 20 and temple 22 of the present application illustrating an exemplary hinge mechanism 24a, 24b. A first component 24a of the hinge mechanism is formed on the lens frame 20, while a second component 24b is formed on the temple 22. In the illustrated, the first component 24a is the female component, while the second component 24b is the male component.

FIG. 2 is a first step of assembly of a temple 22 to the lens frame. Only one end of the lens frame 20 is shown, the other end being identical, if mirrored. The lens frame 20 may take a variety of configurations, but for explanation of the exemplary hinge mechanism 24a, 24b the frame is conventional. That is, the frame 20 has a front frame portion 30 defining dual openings for receiving left and right lenses 32. It goes without saying that the type of lenses 32 are not important to the hinge mechanism 24a, 24b, and may be clear, tinted, prescription, bifocal, etc.

The lens frame 20 further includes a pair of side frame portions 34 which are preferably affixed to the front frame portion 30 on either end. The side frame portions 34 project in parallel in a rearward direction at approximately 90° angles from the nominal plane of the front frame portion 30. For reference purposes, the front frame portion 30 can be considered to be lying in a vertical plane defining lateral left and right directions, while the side frame portions 34 project horizontally rearward. Depending on the style, side frame portions 34 may be at right angles to the front frame portion 30, or may form different angles. For instance, so-called wrap-around sunglasses typically have side frame portions which do not extend back in parallel, but instead are angled slightly apart, with your stems that curve around the wearer's head. The particular angle of the side frame portions 34 is not particularly consequential.

The side frame portions 34 may form outer walls of each of the first component 24a of the hinge mechanism. That is, the illustrated embodiment shows a first component 24a defined by one of the side frame portions 34 and a frame box 36 that defines a receiving cavity 38 therein. The receiving cavity 38 has horizontal openings facing rearward and also laterally inward toward the opposite hinge mechanism (not shown). Alternatively, the first component 24a of the hinge mechanism may be formed separately and attached to the side frame portion 34. That is, the first component 24a may be separately molded and adhered or thermally welded to the side frame portion 34 during manufacture.

Each of the temples 22 includes the second component 24b of the hinge mechanism formed on a front end of an ear stem 40. As mentioned, the second component 24b is the male component of the hinge mechanism, and fits within the receiving cavity 38 of the female component 24a. FIG. 1A is an enlarged view of the male component 24b which includes a shaft 42 projecting generally linearly from the front end of the ear stem 40, and a T-shaped head 44 on the terminal end of the shaft. The T-shaped head 44 may be defined by a pair of oppositely-directed cylindrical stubs 46 that are beveled to smooth their circular outer corners 47, and as such resembles a mallet head. In FIGS. 1 and 1A, the T-shaped head 44 is oriented with an axis 48 of the stubs 46 extending horizontally. The axis 48 is rotated vertically to fully engage the male component 24b with the female component 24a.

The hinge mechanism is configured such that the male component 24b is first inserted into the receiving cavity 38 as indicated by the arrow in FIG. 1 in a laterally outward direction. This step is done with the T-shaped head 44 in a horizontal orientation as shown. The incomplete assembly is seen in FIG. 2, and the temple 22 must be further rotated to complete the coupling.

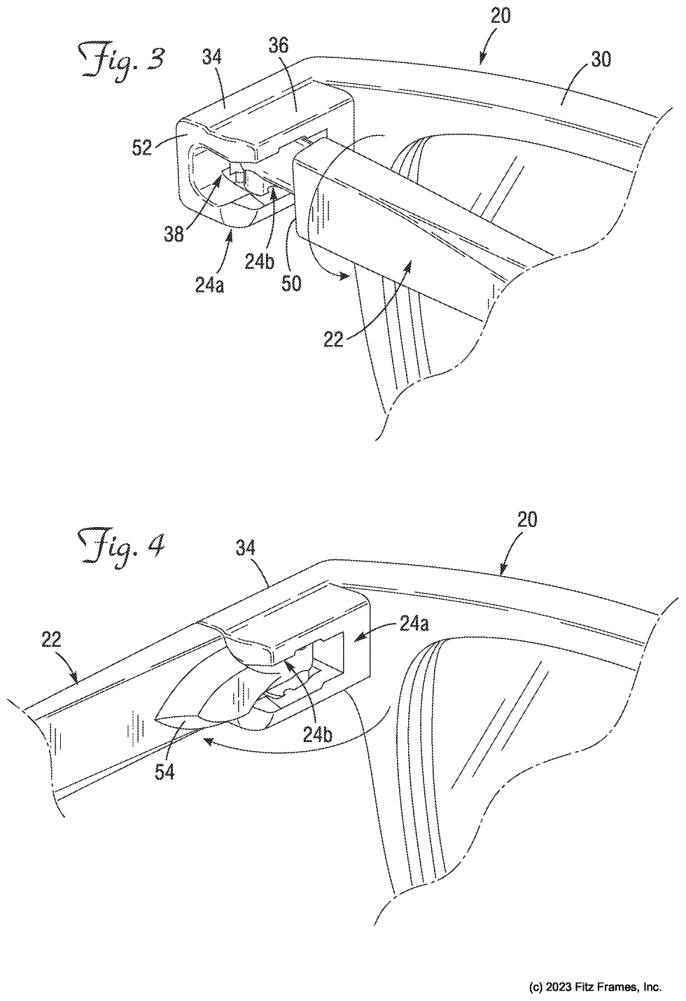

FIG. 3 is a perspective view of a second step of assembly of the temple 22 to the lens frame 20. After inserting the male component 24b into the receiving cavity 38, as in FIG. 2, the temple 22 is rotated 90° in a counterclockwise (CCW) direction as indicated by the movement arrow. Again, this rotates the T-shaped head 44 from a horizontal to a vertical orientation within the receiving cavity 38. The direction that the temple 22 is rotated depends on whether the hinge mechanism is on the left or right side of the lens frame 20. The temple 22 may be rotated counterclockwise (CCW) on the left side, while the right temple is rotated in a clockwise (CW) direction. The structures could be modified so that the rotations are opposite. Indeed, the structures could be modified so that both ear stems 22 are rotated in one or the other direction.

FIG. 4 illustrates the assembled lens frame 20 and temple 22 after rotating the temple to a deployed configuration. That is, the temple 22 is initially inserted laterally into the first component 24a of the hinge mechanism and rotated while in a lateral orientation, generally parallel to and behind the lens frame 20; the folded configuration of the eyeglasses. Subsequently, the temples 22 are rotated approximately 90° in a horizontal plane to unfold the eyeglasses for wearing. It can be seen that as with most eyeglasses, a front corner 50 of the ear stems 40 of each of the temples 22 swings into contact with a rear face 52 of the respective side frame portion 34, thus halting further outward swinging of the temple.

Some eyeglasses incorporate a spring mechanism within the temples 22 to enable the ear stems 40 to flex outward from the 90° orientation to prevent breakage of the temples 22, and such spring mechanism are fully capable of being incorporated into the eyeglasses described herein. For instance, each of the temples 22 may have a reinforcement area 54 adjacent the end of the stem portion, and the reinforcement area 54 may be where a spring mechanism resides.

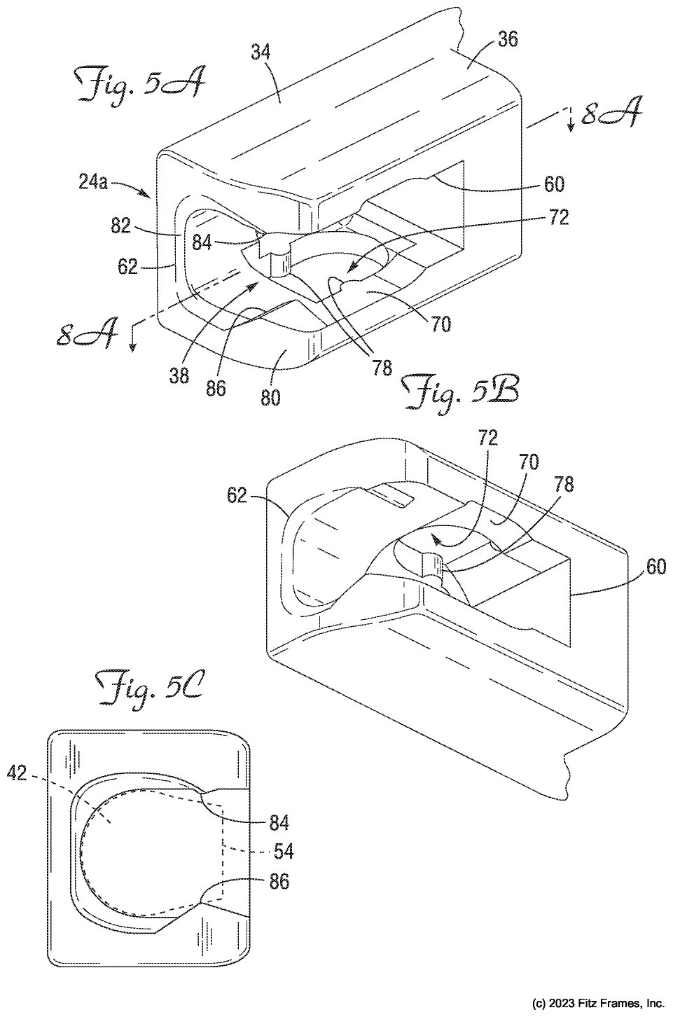

FIGS. 5A and 5B are enlarged perspective views of the exemplary female hinge component 24a at different angles, and FIG. 5C is a rear elevational view thereof. The receiving cavity 38 is defined by specific surfaces and features which enable easy attachment and detachment of male hinge components 24b of the temples 22. In addition, the receiving cavity 38 defines one or more detents that determined the torque needed to open and close the temples 22 (i.e., swinging the temple 22 from the folded orientation of FIG. 3 to the unfolded orientation of FIG. 4).

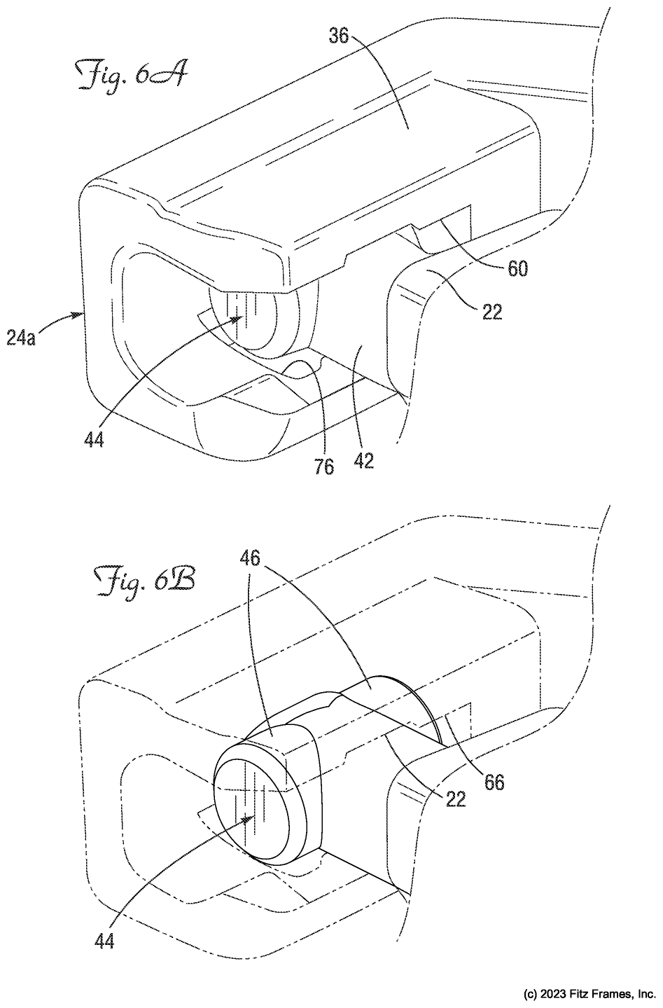

FIG. 6A shows the hinge mechanism during a first step of assembly of the temple 22 to the lens frame 20, and FIG. 6B is the same view with the hinge mechanism shown in phantom.

With reference to FIGS. 5A and 5B, the receiving cavity 38 has two horizontal openings; a lateral opening 60 facing toward the opposite hinge mechanism as well as a rearward opening 62. The lateral opening 60 is substantially rectangular in shape with a larger horizontal than vertical dimension. This proportional shape enables insertion of the T-shaped head 44 of the male hinge component 24b in a horizontal orientation of the T-shaped head (see FIG. 1). As seen in FIGS. 6A-6B, the oppositely-directed cylindrical stubs 46 of the T-shaped head 44 easily pass through the lateral opening 60 until the T-shaped head reaches an outer wall, which may be the inner wall of the side frame portion 34. Inside the receiving cavity 38, through the lateral opening 60, peripheral steps 70 are formed on both floor and ceiling surrounding inner recesses 72. In general, the recesses 72 provides spaces in which the T-shaped head 44 of the male hinge component 24b can rotate 90°.

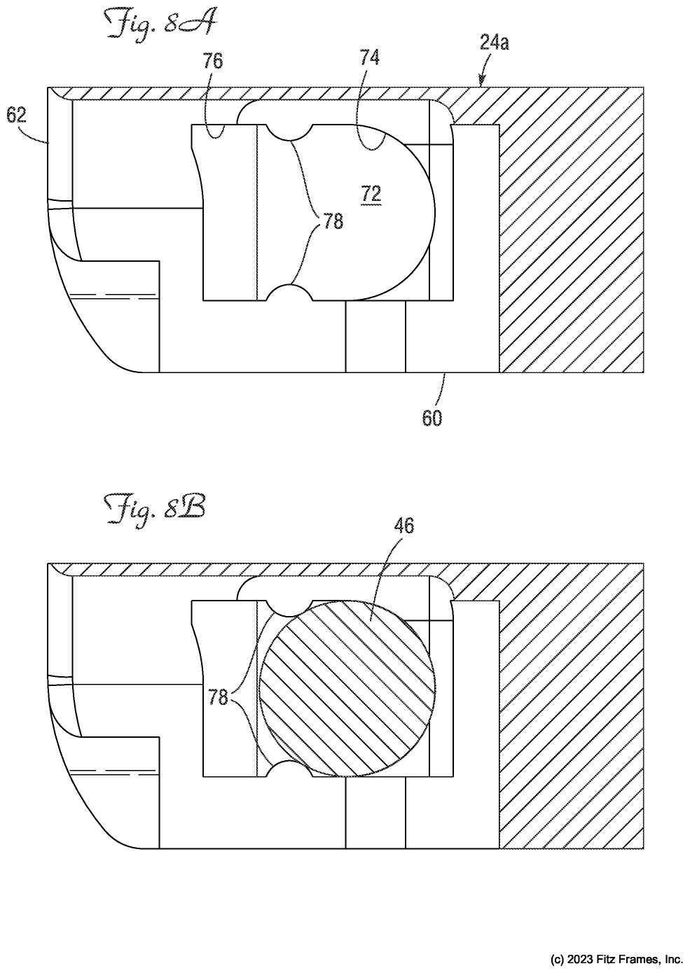

Each of the recesses 72 can be seen in plan view in FIG. 8A, and includes a substantially semi-circular capture portion 74 separated from a relief portion 76 by a pair of detents 78 projecting across the recess toward each other. The detents 78 are desirably rounded, substantially semicircular in shape, and interfere with the cylindrical stubs 46 of the head 44 as the male hinge component 24b is rotated 90° from horizontal to vertical. The arrangement of the recesses 72 on the floor, as in FIG. 8A, is opposite from that on the ceiling. Specifically, the placement of the capture portion 74 on the floor is forward or closer to the lens frame than the relief portion 76, while the placement is reversed on the ceiling. This accommodates rotation and ultimately capture of the T-shaped head 44.

That is, as seen in FIGS. 6A-6B, the cylindrical stubs 46 are initially horizontal. Each of the relief portions 76 enables the stubs 46 to rotate in a counterclockwise (CCW) orientation in the illustrated embodiment. Namely, the left stub 46 in FIGS. 6A-6B goes down, while the right stub goes up. At some point, at around 45° rotation, each of the stubs 46 encounters a respective inwardly-directed detent 78. Depending on the materials of both the female hinge component 24a and T-shaped head 44, as well as the relative dimensions, there is a magnitude of resistance to further rotation at this stage. The T-shaped head 44 can be rotated further past the interfering detents 78 without significant stress or force required.

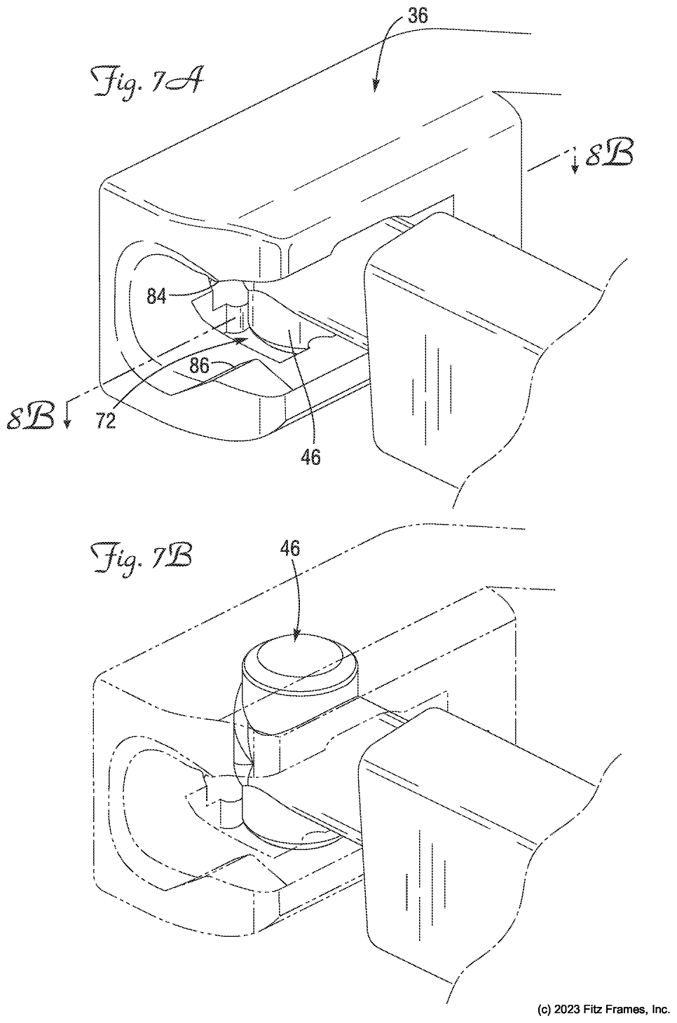

Ultimately, as seen in FIGS. 7A-7B, the T-shaped head 44 is oriented vertically such that the stubs 46 reside within the semi-circular capture portions 74. FIG. 8B is a horizontal sectional view through the assembled hinge mechanism where the shaft stub 46 is shown closely fitting within the semi-circular capture portions 74. Preferably, the diameter of the capture portion 74 is approximately equal to or slightly larger than the diameter of the cylindrical stubs 46. Furthermore, the vertical distance between the floors of the upper and lower capture portions 74 is approximately equal to or slightly greater than the axial length of the T-shaped head 44. In this way, the T-shaped head 44 is captured between the capture portions 74 of the floor and ceiling recesses 72. In this position, the shaft stubs 46 of the male hinge component 24b act as pivots for the temples 22.

Rotating the temples 22 between the horizontal orientation of the mallet-shaped head 44 as in FIG. 6A to the vertical orientation as in FIG. 7A necessarily encounter some resistance due to the interference between the shaft stubs 46 and the detents 78. The magnitude of resistance, or torque, required to rotate the temples 22 may be modified depending on need or taste. That is, a greater amount of torque may be desired if the wearer is not likely to replace the temples 22 during the life of the eyeglasses. The temples 22 are rotated and pop into place for use, without concern for replacing them with new temples. Alternatively, a customer may desire to replace the temples 22 on regular basis, in which case the magnitude of torque needed to rotate the temple 22 can be reduced for easy temple replacement. The magnitude of torque depends on the relative size of the shaft stubs 46 and detents 78, as well as the respective materials. A variety combinations are possible. For example, the lens frames 20 and temple 22 can be formed of a polymer such as nylon 12 which is easily fabricated using molding or rapid prototyping technology. Conversely, the lens frames 20 can be formed of a polymer, while the temples 22 are made of a metal, such as stainless steel or aluminum.

The methodology disclosed in U.S. Pat. No. 11,069,153 for providing bespoke eyeglasses may be utilized to modify the eyeglass components to alter the torque needed to assemble the temples 22 to the lens frame 20. That is, if the customer desires a certain lens frame but multiple pairs of temples, such can be ordered with the lens frame having hinge components which enable easy replacement of the temples. Further, if the wearer buys a pair of eyeglasses, but then requires replacement temples, a new pair of temples 22 can easily be requested using the app-based ordering system, and rapidly manufactured using 3-D prototyping technology.

With reference to FIGS. 5A-5C, the lateral opening 60 extends rearwardly and is open at a rear corner 80 of the female hinge component 24a, as is the rearward opening 62. The rearward opening 62 is substantially circular, and has a beveled peripheral edge 82. At the corner 80, the frame box 36 that defines the female hinge mechanism 24a narrows at upper 84 and lower 86 detents. These are also seen in FIG. 7A and act to resist rotation of the temples 22 from the folded to unfolded positions. The size of the detents 84, 86 relative to the size of the shaft 42 of the male component 24b and the materials of both dictate how much resistance or torque is needed for this rotation. Generally, the narrower the detents 84, 86 relative to the size of the shaft 42 and the harder the materials the greater torque required. Each of the detents 84, 86 is shown formed as a triangular bump having a front-to-rear length and a rounded apex. In the illustrated embodiment, as best seen in FIG. 5C, the lower detent 86 is greater in vertical dimension than the upper detent 84.

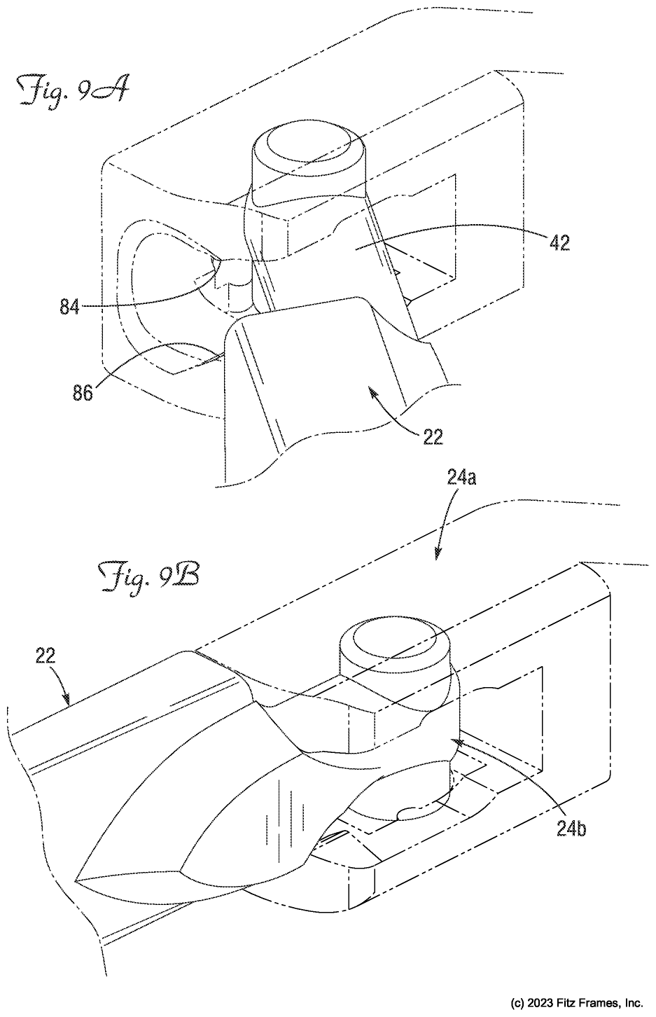

FIG. 9A is an enlarged perspective view of the hinge mechanism in phantom with the assembled temple 22 being rotated toward an unfolded configuration, at about 45°, and FIG. 9B is after unfolding of the temple. The shaft 42 of the male hinge component 24b passes between the opposing detents 84, 86 with which it interferes. Because of the nature of the material of the detents 84, 86, shaft 42, or both, there is compression of the interfering material and thus some resistance to the rotation, or torque, manifested. Preferably, the interference is sufficient to present some but not excessive resistance to rotation, which is overcome with normal force without excessive wear to the components. Ultimately, the temple 22 rotates outward and snaps into place in a perpendicular orientation with respect to the lens frame 20, such as depicted in FIG. 4.

With reference again to FIG. 5C, an outline of the shaft 42 as well as the inner reinforcement 54 is shown at the rear opening 62. The diameter of the shaft 42 closely matches that of the rear opening 62, and the reinforcement 54 which is wedge-shaped in section desirably contacts the detents 84, 86, resulting in the temple 22 being firmly held in the unfolded configuration the reverse rotation, from unfolded to folded, occurs in the same manner, with the detents 84, 86 providing a modicum of resistance.

It should be noted that the amount of resistance to rotation temples 22 may be modified to suit different types of eyeglasses. For example, eyeglasses which are used in sports or work environments in which the wearer may experience jarring or sudden head movements may require a greater resistance to rotation to make sure the temples 22 stay folded or unfolded when necessary. As mentioned, the magnitude of torque required to unfold the temples 22 can be modified by increasing the size of the detents 84, 86, or substituting a harder material. The methodology disclosed in U.S. Pat. No. 11,069,153 for providing bespoke eyeglasses may be utilized to modify the torque. That is, if the wearer requires a different torque, a new lens frame 20 or pair of temples 22 can easily be requested using the app-based ordering system, and rapidly manufactured using 3-D prototyping technology. The present application thus contemplates methods of selecting eyeglass frames and/or temples using an app-based system, the components then being rapidly manufactured and shipped. The vendor may supply the lenses for the lens frames, either prescription or not, or may just send the lens frames to be coupled with lenses by the customer or an optometrist.

The disclosed hinge may be used with an additively manufactured, interchangeable temple design that is simple to assemble/disassemble without compromising the security of the hinge and temple when assembled. The quarter twist (90 degree) assembly action allows an ordinary customer to quickly assemble the hinge without using any tools or fasteners. This gives the customer the accessibility to customize their glasses or replace a temple whenever or wherever they'd like.

When someone installs the temples into the frame, they rotate the temple 90 degrees. The first set of detents (installation detents) secure the pivot into place and create the axis that the temple rotates around. To uninstall the temples, rotate the temple 90 degrees in the opposite direction and remove the temple. The second set of detents (frame detent) snaps the temple in the open position and has a similar feel to opening a spring hinge on common eyewear without the fragility of the spring hinge itself or the necessity of tools to install it.

The size of the installation detents can be adjusted to increase/decrease the torque necessary to install/uninstall the temples. The same is possible for the frame detents to increase/decrease the torque needed to open and close the temples.

The average torque to install the temples is 0.106 Nm. The average torque to uninstall the temples is 0.085 Nm. The average torque to open/close the temples is 0.083 Nm.

The presently disclosed hinge mechanism provides a number of advantages over earlier replacement temples, not the least of which is the elimination of the need for any pins or tools to assemble or disassemble the temples. Further, there are no small or weak parts within the hinge mechanism which might break. The use of stubby and rounded mating parts reduces the chance of breakage and smooths the operation. The hinge mechanism described herein may be adjusted in two ways. First, the torque required to assemble the temples to the lens frame can be adjusted by modifying the detents 78 within the female hinge component 24a, or by modifying the size of the head 44 of the male hinge component 24b. Secondly, the torque required to transition the temples 22 from the folded to the unfolded position can be adjusted by modifying the detents 84, 86 within the female hinge component 24a, or by modifying the size of the head 44 of the male hinge component 24b. Finally, both adjustments may be affected by the choice of materials of one or both of the hinge components 24a, 24b.

Finally, it should be noted that although in the illustrated embodiment the female component of the hinge mechanism is provided on the lens frame, while a male component is on each of the temples, the male/female relationship of the two components might be reversed. That is, it does not require a great leap of imagination to imagine that the female component is instead formed on the terminal end of each of the temples 22, while the mallet-shaped head 44 defining the male component could project laterally inward from each of the side frame portions 34. As before, each of the temples 22 could then be rotated 90° about its own axis to couple the hinge components, and then the female component on the temples 22 would be configured to allow unfolding of the temples.

It is claimed:

1. A hinge mechanism comprising a two-part hinge for eyeglasses, comprising:
a male component having a head; and
a female component having a cavity adapted to snugly receive and secure the head in the cavity during normal use of the eyeglasses;
wherein the head and the cavity are configured such that rotation in a first direction of the head relative to the cavity, by a hand of a human user, secures the head in the cavity, and rotation in a second direction of the head relative to the cavity, by a hand of a human user, releases the head from the cavity, and the first direction is opposite the second direction.

2. The hinge mechanism of claim 1 comprising a lens frame and a temple, wherein one of the male component and the female component is attached to the lens frame, and the other of the male component and the female component is attached to the temple.

3. The hinge mechanism of claim 1 wherein the head is T-shaped.

4. The hinge mechanism of claim 3 wherein the cavity defines an opening sized to permit passage of the T-shaped head in a first orientation, and the cavity further defines two recesses facing each other, wherein rotation of the T-shaped head 90 degrees to a second orientation perpendicular to the first orientation secures oppositely directed elements of the head in the two recesses.

5. The hinge mechanism of claim 3 wherein the male component is attached to the temple defining a longitudinal axis and the head has a longitudinal shaft and a pair of oppositely directed lateral shaft stubs extending from the shaft having rounded ends.

6. The hinge mechanism of claim 5 wherein when the temple is coupled to the lens frame, the shaft stubs form pivots within the recesses to permit movement of the temple from a folded position aligned with the lens frame to an unfolded position rotated approximately 90 degrees from the lens frame, and the cavity further includes a pair of detents arranged to interfere with the temple so as to require a torque to move the temple from the folded position to the unfolded position, and vice versa.

7. The hinge mechanism of claim 1 wherein relative rotation of the male component to the female component by a 90 degrees secures the head in the cavity.

8. A hinge mechanism for eyeglasses, comprising:
a lens frame having a female hinge component on either end; and
a pair of temples each having a male hinge component on an end thereof, wherein the male hinge component has a T-shaped head that fits within a cavity within the female hinge component, and the cavity and T-shaped head are configured such that relative rotation of the temple about its longitudinal axis, by a hand of a human user, couples the temple to the lens frame, and a reverse rotation, by a hand of a human user, decouples the temple from the lens frame.

9. The hinge mechanism of claim 8 wherein the temple defines a longitudinal axis and the head has a longitudinal shaft and a pair of oppositely directed lateral shaft stubs extending from the shaft having rounded ends.

10. The hinge mechanism of claim 8 wherein the cavity defines an opening sized to permit passage of the T-shaped head in a first orientation, and the cavity further defines two recesses facing each other, wherein rotation of the T-shaped head 90 degrees to a second orientation perpendicular to the first orientation secures oppositely directed elements of the head in the two recesses.

11. The hinge mechanism of claim 10, wherein each recess includes a capture portion separated from a relief portion by a pair of detents projecting across the recess toward each other, and wherein the capture portion is sized to closely retain the oppositely directed elements of the head while the pair of detents are spaced apart closer than a width of the oppositely directed elements.

12. The hinge mechanism of claim 8 wherein when the temple is coupled to the lens frame, oppositely directed elements of the T-shaped head form pivots within the recesses to permit movement of the temple from a folded position aligned with the lens frame to an unfolded position rotated approximately 90 degrees from the lens frame, and the cavity further includes a pair of detents arranged to interfere with the temple so as to require a torque to move the temple from the folded position to the unfolded position, and vice versa.

13. The hinge mechanism of claim 8 wherein relative rotation of the male hinge component to the female hinge component by a 90 degrees secures the head in the cavity.

14. A hinge mechanism for eyeglasses, comprising:
a lens frame having a female hinge component on either end; and
a pair of temples each having a male hinge component on a longitudinal end thereof, wherein the male hinge component has a shaped head that fits within a cavity within the female hinge component, and the cavity and shaped head are configured such that relative rotation of the temple about its longitudinal axis by 90°, by a hand of a human user, couples the temple to the lens frame, and a reverse rotation, by a hand of a human user, decouples the temple from the lens frame.

15. The hinge mechanism of claim 14 wherein the head is T-shaped.

16. The hinge mechanism of claim 15 wherein the temple defines a longitudinal axis and the head has a longitudinal shaft and a pair of oppositely directed lateral shaft stubs extending from the shaft having rounded ends.

17. The hinge mechanism of claim 15 wherein the cavity defines an opening sized to permit passage of the T-shaped head in a first orientation, and the cavity further defines two recesses facing each other, wherein rotation of the T-shaped head 90 degrees to a second orientation perpendicular to the first orientation secures oppositely directed elements of the head in the two recesses.

18. The hinge mechanism of claim 17, wherein each recess includes a capture portion separated from a relief portion by a pair of detents projecting across the recess toward each other, and wherein the capture portion is sized to closely retain the oppositely directed elements of the head while the pair of detents are spaced apart closer than a width of the oppositely directed elements.

19. The hinge mechanism of claim 15 wherein when the temple is coupled to the lens frame, oppositely directed elements of the T-shaped head form pivots within the recesses to permit movement of the temple from a folded position aligned with the lens frame to an unfolded position rotated approximately 90 degrees from the lens frame, and the cavity further includes a pair of detents arranged to interfere with the temple so as to require a torque to move the temple from the folded position to the unfolded position, and vice versa.
